(19) United States
(12) Patent Application Publication
(10) Pub. No.: US 2015/0172541 A1
(43) Pub. Date: Jun. 18, 2015

(54) Camera Array Analysis Mechanism

(71) Applicant: Glen J. Anderson, Beaverton, OR (US)

(72) Inventor: Glen J. Anderson, Beaverton, OR (US)

(21) Appl. No.: 14/362,070

(22) PCT Filed: Dec. 17, 2013
(86) PCT No.: PCT/US2013/075717

§ 371 Date: May 30, 2014

(51) Int. Cl. H04N 5/232

(52) U.S. Cl. CPC H04N 5/23232

(57) ABSTRACT

A method is described. The method detecting that a media capture device is prepared to capture media data of a scene, capturing data associated with the scene, analyzing the scene data to identify and classify behavior of one or more objects in the scene and adjusting the media capture device based on the scene data analysis to optimize the capture of the media data.

### FIELD

Embodiments described herein generally relate to perceptual computing, and more particularly, to subject monitoring using camera arrays.

### BACKGROUND

Camera arrays feature multiple lenses that permit the simultaneous capture of multiple versions of a single scene. For instance, each lens in an array may be set to a different focal distance, thus enabling the capture of image data with depth information for different objects in the scene. However, when some objects in the scene are behaving differently (e.g., some objects are moving while others are stationary), applying a similar timing and analysis to the entire array may not be optimal.

### BRIEF DESCRIPTION OF THE DRAWINGS

Embodiments are illustrated by way of example, and not by way of limitation, in the figures of the accompanying drawings in which like reference numerals refer to similar elements.

FIG. 1 is a block diagram illustrating one embodiment of a system for capturing media data.

FIG. 2 is a flow diagram illustrating one embodiment of a camera array analysis process.

FIG. 3 is an illustrative diagram of an exemplary system.

FIG. 4 is an illustrative diagram of an exemplary system.

### DETAILED DESCRIPTION

In the following description, numerous specific details are set forth. However, embodiments, as described herein, may be practiced without these specific details. In other instances, well-known circuits, structures and techniques have not been shown in details in order not to obscure the understanding of this description.

Throughout this document, terms like “logic”, “component”, “module”, “framework”, “engine”, “store”, or the like, may be referenced interchangeably and include, by way of example, software, hardware, and/or any combination of software and hardware, such as firmware.

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device). In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

Some portions of the detailed descriptions provide herein are presented in terms of algorithms and symbolic representations of operations on data bits within a computer memory. Unless specifically stated otherwise, as apparent from the following discussion, it is appreciated that throughout the description, discussions utilizing terms such as “calculating,” “computing,” “determining” “estimating” “storing” “collecting” “displaying,” “receiving,” “consolidating,” “generating,” “updating,” or the like, refer to the action and processes of a computer system, or similar electronic computing device, that manipulates and transforms data represented as physical (electronic) quantities within the computer system's circuitry including registers and memories into other data similarly represented as physical quantities within the computer system memories or registers or other such information storage, transmission or display devices.

While the following description sets forth various implementations that may be manifested in architectures such system-on-a-chip (SoC) architectures for example, implementation of the techniques and/or arrangements described herein are not restricted to particular architectures and/or computing systems and may be implemented by any architecture and/or computing system for similar purposes. For example, various architectures employing, for example, multiple integrated circuit (IC) chips and/or packages, and/or various computing devices and/or consumer electronic (CE) devices such as set top boxes, smart phones, etc., may implement the techniques and/or arrangements described herein. Further, while the following description may set forth numerous specific details such as logic implementations, types and interrelationships of system components, logic partitioning/integration choices, etc., claimed subject matter may be practiced without such specific details. Furthermore, some material such as, for example, control structures and full software instruction sequences, may not be shown in detail in order not to obscure the material disclosed herein.

Systems, apparatus, articles, and methods are described below including operations for managing and accessing personal media data based on a perception of an operator of the device that captured the media data, as determined during a capture event.

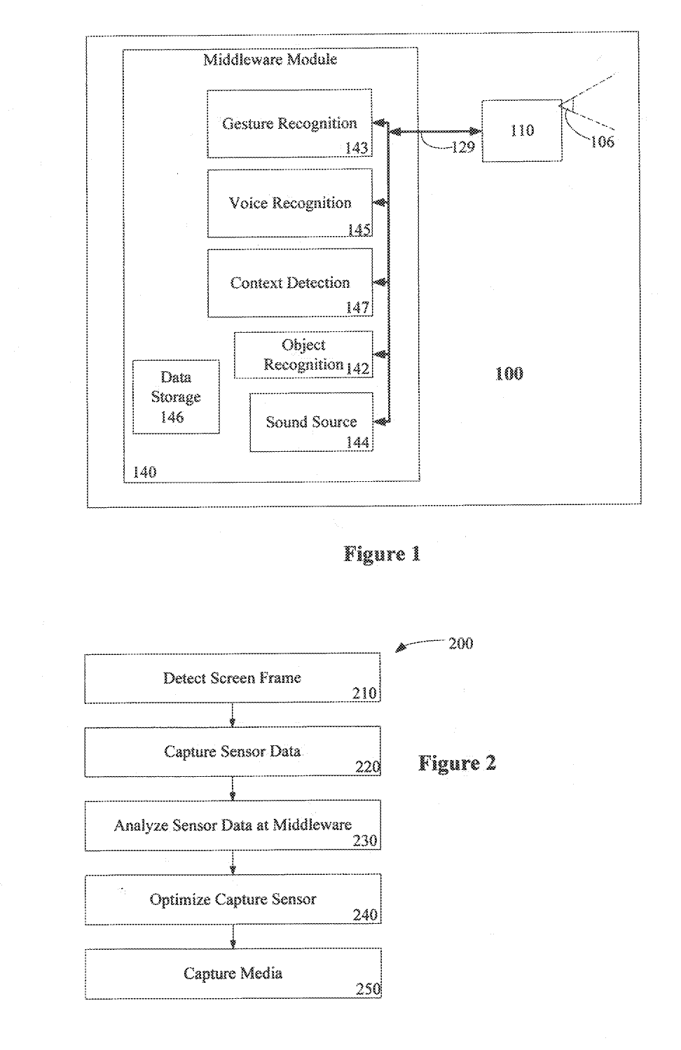

FIG. 1 is a block diagram illustrating one embodiment of a system 100 for capturing media data. System 100 includes media capture device 110 having one or more media capture sensors 106. In various embodiments, media capture device 110 includes, or is a component of, a mobile computing platform, such as a wireless smartphone, tablet computer, ultrabook computer, or the like. In other embodiments, media capture device 110 may be any wearable device, such as a headset, wrist computer, etc., or may be any immobile sensor installation, such as a security camera, etc. In still other embodiments, media capture device 110 may be an infrastructure device, such as a television, set-top box, desktop computer, etc.

Generally, media capture sensor 106 is any conventional sensor or sensor array capable of collecting media data. In certain embodiments, for example where the capture device 110 is a mobile computing platform, the media capture sensor 106 has a field of view (FOV) that is oriented to capture media data pertaining to a subject. In certain other embodiments, for example where the capture device 110 is immobile, the media capture sensor 106 has a field of view (FOV) that is oriented to also capture media data including an operator.

In one embodiment, media capture sensor 106 includes a plurality of integrated and/or discrete sensors that form part of a distributed sensor array. In such an embodiment, media capture sensor 106 includes a camera array. In a further embodiment, the sensor data collected includes one or more fields of perception sensor data 129 transmitted via conventional wireless/wired network/internet connectivity.

System 100 further includes middleware module 140 to receive perception sensor data 129 having potentially many native forms (e.g., analog, digital, continuously streamed, aperiodic, etc.). In one embodiment, middleware module 140 functions as a hub for multiplexing and/or de-multiplexing a plurality of streams of sensor data 129. Generally, middleware module 140 may be a component of the media capture device 110, or may be part of a separate platform.

Middleware module 140 may employ one or more sensor data processing modules, such as object recognition module 142, sound source module 144, gesture recognition module 143, voice recognition module 145, context determination module 147, etc., each employing an algorithm to analyze the received data to produce perception data. According to one embodiment, the perception data is a low level parameterization, such as a voice command, gesture, or facial expression (e.g., smile, frown, grimace, etc.), or a higher level abstraction, such as a level of attention, or a cognitive load (e.g., a measure of mental effort) that may be inferred or derived indirectly from one or more fields in sensor data 129. For example, a level of attention may be estimated based on eye tracking and/or on a rate of blinking, etc., while a cognitive load may be inferred based on pupil dilation and/or a heart rate-blood pressure product. Embodiments of the invention are not limited with respect to specific transformations of sensor data 129 into perception data, which is stored in data storage.

In a further embodiment, each item of perception data may correspond to sensor data 129 collected in response to, or triggered by, a media capture event. In such an embodiment, perception data stored in data storage 146 may be organized as files with contemporaneous perception-media data associations then generated by linking a perception data file with a media data file having approximately the same file creation time.

According to one embodiment, system 100 performs pre-image analysis to enhance media capture performance. In such an embodiment, scene data from media capture sensor 106 is implemented to identify objects and classify behavior prior to capture of the media. In response, commands are transmitted back to media capture device 110 to optimize settings for sensor 106. In one embodiment, the pre-image analysis process treats imagery from at least one lens in sensor 106 different from others based on information received regarding behavior and/or identification of objects in a scene. In such an embodiment, the information is obtained by devoting some lenses to obtaining data for scene analysis as opposed to simply varying the lenses across typical dimensions such as focal length. In a further embodiment, microphones, or other sensors, are used to provide information for scene analysis relative to the array.

FIG. 2 is a flow diagram illustrating one embodiment of a pre-image analysis process 200 performed at system 100. At processing block 200, media capture device 110 detects that a user is framing a scene for media capture. At processing block 220, media capture sensor 106 captures scene analysis data. For instance, media capture sensor 106 may capture light, sound, vibration and movement data from a scene to be captured. At processing block 230, the captured data is received and analyzed at middleware module 140. According to one embodiment, object recognition module 142 analyzes the data to identify objects and or/faces in the scene, while sound source module 144 determines a source of sound input from a scene based on data received from microphones and video analysis of mouth movement.

Similarly, gesture recognition module 143, voice recognition module 145, context determination module 147 is implemented to provide additional contextual analysis (e.g., classify the behavior/activity of objects, determine levels of motion in individual objects and determine levels of overall emotion of subjects). In one embodiment, lenses assigned to subject behavior tracking may perform the task before, during or after image capture by the array.

At processing block 240, media capture sensor 106 is optimized to improve media capture. According to one embodiment, lenses of a camera array component of media capture sensor 106 are optimized to improve image capture. In a further embodiment, associated data may be stored in data storage 146 as image metadata for subsequent post-processing analysis, and enable new features in post-processing (e.g., selecting imagery from corresponding lenses to automatically creating the best image, or for presenting to a user for choices in browsing or user interface editing). At processing block 250, the media data of the scene is captured.

Based on the above-described pre-image analysis process, scenarios in which sensor input (or context determinations made via middleware module algorithms) causes the settings of media capture device 110 to be optimized are determined by the corresponding algorithms. Table 1 illustrates one embodiment of array adjustment optimization rules performed based on sensor detection and corresponding algorithm determination.

TABLE 1

| Sensor/Algorithm | Algorithm | Array Adjustment |
|---|---|---|
| Detection | Determination | Rule |
| Object distance | Subject is changing dis- | Adjust focal depths to |
| change | tance relative to camera | optimize for subjects |
| | | changing distance |
| Speech input | Subject is talking | Use a lens to video |
| | | record subject at optimal |
| | | focal depth |
| Object motion | Subject is moving | Adjust array settings for |
| | | a range of lower |
| | | exposures |
| Object or face | Historical correlations | Adjust array settings for |
| recognition | of subject behavior such | a range of lower |
| | as “tends to move” | exposures |
| Face detection | Tendency of a larger num- | Set array to take more |
| | ber of faces to require | quick-sequence images |
| | more shots for good group | for later adjustments |
| | photo | |
| Ambient | High ambient sound | Set array to take more |
| sound level | correlates with more | quick-sequence images |
| | action | and for low exposure al- |
| | | ternatives for later |
| | | adjustments |
| Light level | Indoor detection | Set array for higher range |
| | | of exposure levels |
| Ambient sound | Detection of sporting | Set array for “sport set- |
| | event | ting” range of exposure |

As discussed above, pre-image analysis process enables various enhancements to be realized. For instance, if an object and its behavior are classified as being in motion and having high potential for motion (e.g., a dog being identified and classified as moving), an exposure setting for a camera array may be shorter. In another example, focal length depth settings across the camera array may be adjusted to increase odds of a good image in a proper direction (e.g., closer focal depths if a skate-boarder is moving closer to the camera) if a detected object is moving closer or farther away. Moreover, one of the lenses may be focused on a speaker and automatically set to video, if speech is detected, so that video of the speaker can be captured for later use. In yet another example, a differential focus level of the camera array may be used to automatically capture additional photos of a subject known to be difficult to capture (e.g., a child).

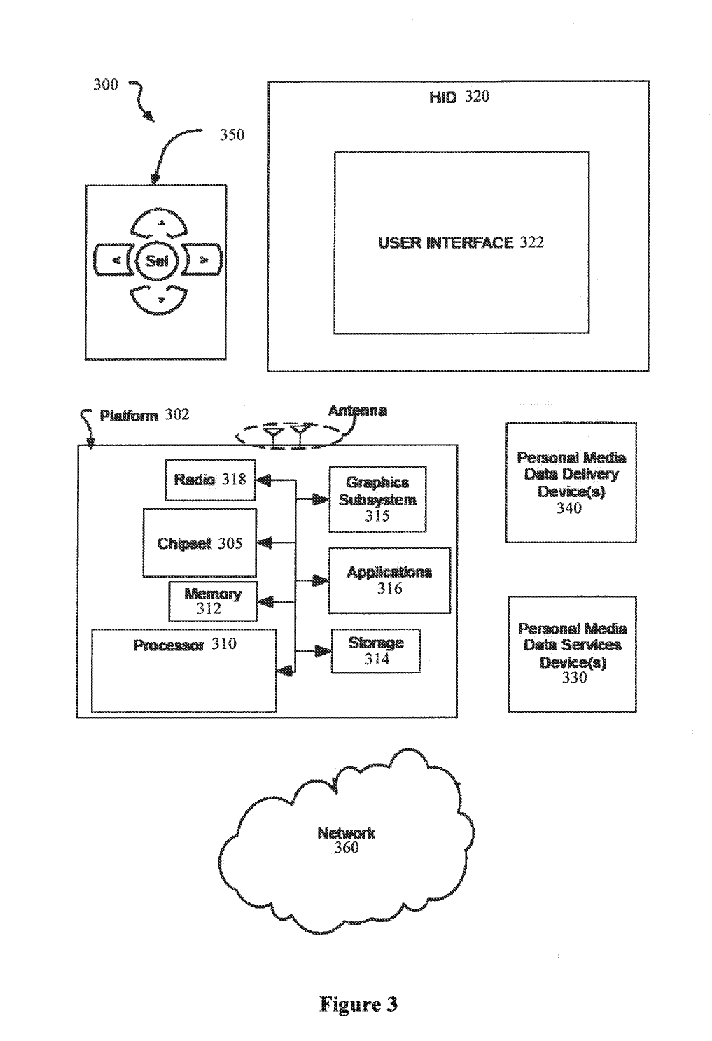

FIG. 3 is an illustrative diagram of an exemplary system 300, in accordance with embodiments. System 300 may implement all or a subset of the various functional blocks depicted in FIG. 1. For example, in one embodiment the system 100 is implemented by system 300. System 300 may be a mobile device although system 300 is not limited to this context. For example, system 300 may be incorporated into a laptop computer, ultra-laptop computer, tablet, touch pad, portable computer, handheld computer, palmtop computer, cellular telephone, smart device (e.g., smart phone, smart tablet or mobile television), mobile internet device (MID), wearable computing device, messaging device, data communication device, and so forth. System 300 may also be an infrastructure device. For example, system 300 may be incorporated into a large format television, set-top box, desktop computer, or other home or commercial network device.

In various implementations, system 300 includes a platform 302 coupled to a HID 320. Platform 302 may receive captured personal media data from a personal media data services device(s) 330, a personal media data delivery device(s) 340, or other similar content source. A navigation controller 350 including one or more navigation features may be used to interact with, for example, platform 302 and/or HID 320. Each of these components is described in greater detail below.

In various implementations, platform 302 may include any combination of a chipset 305, processor 310, memory 312, storage 314, graphics subsystem 315, applications 316 and/or radio 318. Chipset 705 may provide intercommunication among processor 310, memory 312, storage 314, graphics subsystem 315, applications 316 and/or radio 318. For example, chipset 305 may include a storage adapter (not depicted) capable of providing intercommunication with storage 314.

Processor 310 may be implemented as a Complex Instruction Set Computer (CISC) or Reduced Instruction Set Computer (RISC) processors; x86 instruction set compatible processors, multi-core, or any other microprocessor or central processing unit (CPU). In various implementations, processor 310 may be a multi-core processor(s), multi-core mobile processor(s), and so forth. In one exemplary embodiment, processor 310 invokes or otherwise implements process 200 and the various modules described as components of middleware 140.

Memory 312 may be implemented as a volatile memory device such as, but not limited to, a Random Access Memory (RAM), Dynamic Random Access Memory (DRAM), or Static RAM (SRAM).

Storage 314 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 314 may include technology to increase the storage performance enhanced protection for valuable digital media when multiple hard drives are included, for example.

Graphics subsystem 315 may perform processing of images such as still or video media data for display. Graphics subsystem 315 may be a graphics processing unit (GPU) or a visual processing unit (VPU), for example. An analog or digital interface may be used to communicatively couple graphics subsystem 315 and display 320. For example, the interface may be any of a High-Definition Multimedia Interface, Display Port, wireless HDMI, and/or wireless HD compliant techniques. Graphics subsystem 315 may be integrated into processor 310 or chipset 705. In some implementations, graphics subsystem 315 may be a stand-alone card communicatively coupled to chipset 305.

The perception-media data associations and related media data management and accessing techniques described herein may be implemented in various hardware architectures. For example, graphics and/or video functionality may be integrated within a chipset. Alternatively, a discrete graphics and/or video processor may be used. As still another embodiment, the methods and functions described herein may be provided by a general purpose processor, including a multi-core processor. In further embodiments, the methods and functions may be implemented in a purpose-built consumer electronics device.

Radio 318 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 318 may operate in accordance with one or more applicable standards in any version.

In various implementations, HID 320 may include any television type monitor or display. HID 320 may include, for example, a computer display screen, touch screen display, video monitor, television-like device, and/or a television. HID 320 may be digital and/or analog. In various implementations, HID 320 may be a holographic display. Also, HID 320 may be a transparent surface that may receive a visual projection. Such projections may convey various forms of information, images, and/or objects. For example, such projections may be a visual overlay for a mobile augmented reality (MAR) application. Under the control of one or more software applications 316, platform 302 may display user interface 322 on HID 320.

In various implementations, personal media services device(s) 330 may be hosted by any national, international and/or independent service and thus accessible to platform 302 via the Internet, for example. Personal media services device(s) 330 may be coupled to platform 702 and/or to display 320. Platform 302 and/or personal services device(s) 330 may be coupled to a network 760 to communicate (e.g., send and/or receive) media information to and from network 360. Personal media delivery device(s) 340 also may be coupled to platform 302 and/or to HID 320.

In various implementations, personal media data services device(s) 330 may include a cable television box, personal computer, network, telephone, Internet enabled devices or appliance capable of delivering digital information and/or content, and any other similar device capable of unidirectionally or bidirectionally communicating content between a media data provider and platform 302, via network 360 or directly. It will be appreciated that the content may be communicated unidirectionally and/or bidirectionally to and from any one of the components in system 700 and a provider via network 360. Examples of personal media include any captured media information including, for example, video, music, medical and gaming information, and so forth.

Personal media data services device(s) 330 may receive content including media information with examples of content providers including any cable or satellite television or radio or Internet content providers. The provided examples are not meant to limit implementations in accordance with the present disclosure in any way.

In various implementations, platform 302 may receive control signals from navigation controller 350 having one or more navigation features. The navigation features of controller 350 may be used to interact with user interface 322, for example. In embodiments, navigation controller 350 may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 350 may be replicated on a display (e.g., HID 320) by movements of a pointer, cursor, focus ring, or other visual indicators displayed on the display. For example, under the control of software applications 316, the navigation features located on navigation controller 350 may be mapped to virtual navigation features displayed on user interface 322, for example. In embodiments, controller 350 may not be a separate component but may be integrated into platform 302 and/or HID 320. The present disclosure, however, is not limited to the elements or in the context shown or described herein.

In various implementations, drivers (not shown) may include technology to enable users to instantly turn on and off platform 302 like a television with the touch of a button after initial boot-up, when enabled, for example. Program logic may allow platform 302 to stream content to media adaptors or other personal media services device(s) 330 or personal media delivery device(s) 340 even when the platform is turned “off.” In addition, chipset 305 may include hardware and/or software support for 8.1 surround sound audio and/or high definition (7.1) surround sound audio, for example. Drivers may include a graphics driver for integrated graphics platforms. In embodiments, the graphics driver may comprise a peripheral component interconnect (PCI) Express graphics card.

In various implementations, any one or more of the components shown in system 300 may be integrated. For example, platform 302 and personal media data services device(s) 330 may be integrated, or platform 302 and captured media data delivery device(s) 340 may be integrated, or platform 302, personal media services device(s) 330, and personal media delivery device(s) 340 may be integrated, for example. In various embodiments, platform 302 and HID 320 may be an integrated unit. HID 320 and content service device(s) 330 may be integrated, or HID 320 and personal media delivery device(s) 340 may be integrated, for example. These examples are not meant to limit the present disclosure.

In various embodiments, system 300 may be implemented as a wireless system, a wired system, or a combination of both. When implemented as a wireless system, system 300 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 300 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 302 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 3.

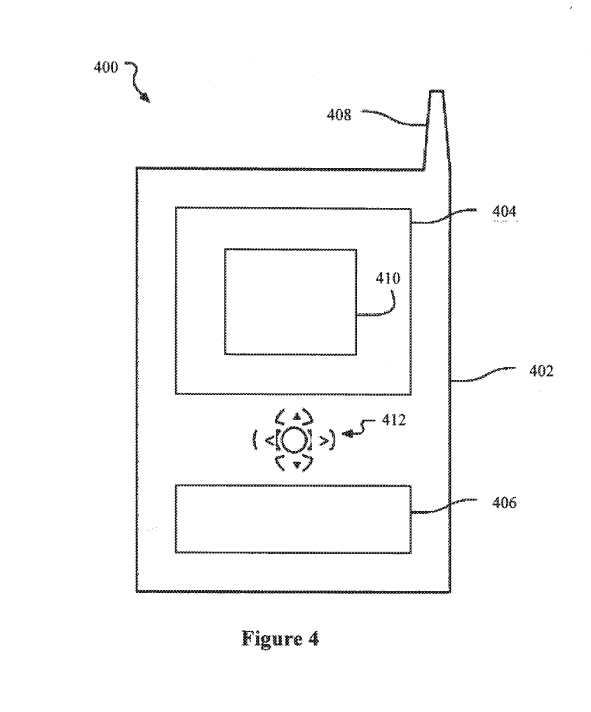

As described above, system 300 may be embodied in varying physical styles or form factors. FIG. 4 illustrates embodiments of a small form factor device 400 in which system 300 may be embodied. In embodiments, for example, device 400 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers configured to be worn by a person, such as a wrist computer, finger computer, ring computer, eyeglass computer, belt-clip computer, arm-band computer, shoe computers, clothing computers, and other wearable computers. In various embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 4, device 400 may include a housing 402, a display 404, an input/output (I/O) device 406, and an antenna 408. Device 400 also may include navigation features 412. Display 404 may include any suitable display unit for displaying information appropriate for a mobile computing device. I/O device 406 may include any suitable I/O device for entering information into a mobile computing device. Examples for I/O device 406 may include an alphanumeric keyboard, a numeric keypad, a touch pad, input keys, buttons, switches, rocker switches, microphones, speakers, voice recognition device and software, and so forth. Information also may be entered into device 400 by way of microphone (not shown). Such information may be digitized by a voice recognition device (not shown). The embodiments are not limited in this context.

Embodiments may be implemented as any or a combination of: one or more microchips or integrated circuits interconnected using a parentboard, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to performs acts of the method, or of an apparatus or system for facilitating content-morphism and distribution of advertisement content and user content according to embodiments and examples described herein.

Some embodiments pertain to Example 1 that includes a method comprising detecting that a media capture device is prepared to capture media data of a scene, capturing data associated with the scene, analyzing the scene data to identify and classify behavior of one or more objects in the scene and adjusting the media capture device based on the scene data analysis to optimize the capture of the media data.

Example 2 includes the subject matter of Example 1 and further comprising capturing media data of the scene after adjusting the media capture device.

Example 3 includes the subject matter of Example 1 and wherein capturing data associated with the scene comprises capturing light, sound, vibration and movement data from the scene.

Example 4 includes the subject matter of Example 1 and wherein capturing data comprises a camera array having two or more lenses to capture the data.

Example 5 includes the subject matter of Example 4 and wherein a first of the two or more lenses to capture the scene data.

Example 6 includes the subject matter of Example 1 and wherein analyzing the scene data comprises analyzing the scene data to identify one or more objects in the scene.

Example 7 includes the subject matter of Example 1 and wherein analyzing the scene data comprises analyzing the scene data to recognize one or more faces in the scene.

Example 8 includes the subject matter of Example 5 and wherein analyzing the scene data comprises determining a source of sound input from a scene.

Example 9 includes the subject matter of Example 8 and wherein the source of sound input from the scene is determined based on sound data received from microphones and video analysis of mouth movement from data captured by the one or more lenses.

Example 10 includes the subject matter of Example 4 and wherein adjusting the media capture device comprises optimizing the two or more lenses to improve image capture.

Some embodiments pertain to Example 1 that includes a media data management system comprising a media capture device to capture data associated with a scene prior to capturing media data for the scene and a middleware module to analyze the scene data to identify and classify behavior of one or more objects in the scene and adjust the media capture device based on the scene data analysis to optimize the capture of the media data.

Example 12 includes the subject matter of Example 11 and wherein the media capture device captures media data of the scene after the adjustment.

Example 13 includes the subject matter of Example 11 and wherein the media capture device captures light, sound, vibration and movement data from the scene.

Example 14 includes the subject matter of Example 11 and wherein the media capture device comprises a camera array having two or more lenses to capture the data.

Example 15 includes the subject matter of Example 14 and wherein a first of the two or more lenses to capture the scene data.

Example 16 includes the subject matter of Example 15 and wherein the middleware module comprises an object recognition module to identify one or more objects and in one or more faces in the scene.

Example 17 includes the subject matter of Example 11 and wherein the media capture device comprises one or more microphones.

Example 18 includes the subject matter of Example 11 and wherein the middleware module further comprises a sound source module to determine a source of sound input from the scene.

Example 19 includes the subject matter of Example 18 and wherein the source of sound input from the scene is determined based on sound data received from microphones and video analysis of mouth movement from data captured by the one or more lenses.

Example 20 includes the subject matter of Example 14 and wherein adjusting the media capture device comprises optimizing the two or more lenses to improve image capture.

Some embodiments pertain to Example 21 that includes a media capture device comprising media capture sensors to data capture associated with a scene prior to capturing media data for the scene and a middleware module to analyze the scene data to identify and classify behavior of one or more objects in the scene and adjust one or more of the media capture sensors based on the scene data analysis to optimize the capture of the media data.

Example 22 includes the subject matter of Example 21 and wherein the media capture sensors comprise a camera array having two or more lenses to capture the data and one or more microphones.

Example 23 includes the subject matter of Example 22 and wherein the middleware module comprises an object recognition module to identify one or more objects and in one or more faces in the scene and a sound source module to determine a source of sound input from the scene.

Example 24 includes the subject matter of Example 23 and wherein the source of sound input from the scene is determined based on sound data received from microphones and video analysis of mouth movement from data captured by the one or more lenses.

Some embodiments pertain to Example 25 that includes a machine-readable medium comprising a plurality of instructions that in response to being executed on a computing device, causes the computing device to carry out operations according to any one of claims 1-10.

Some embodiments pertain to Example 26 that includes a system comprising a mechanism to carry out operations according to any one of claims 1 to 10.

Some embodiments pertain to Example 27 that includes means to carry out operations according to any one of claims 1 to 10.

Some embodiments pertain to Example 28 that includes a computing device arranged to carry out operations according to any one of claims 1 to 10.

Some embodiments pertain to Example 29 that includes a communications device arranged to carry out operations according to any one of claims 1 to 10.

Some embodiments pertain to Example 30 that includes a machine-readable medium comprising a plurality of instructions that in response to being executed on a computing device, causes the computing device to carry out operations comprising detecting that a media capture device is prepared to capture media data of a scene, capturing data associated with the scene, analyzing the scene data to identify and classify behavior of one or more objects in the scene and adjusting the media capture device based on the scene data analysis to optimize the capture of the media data.

Example 31 includes the subject matter of Example 30 and further comprising capturing media data of the scene after adjusting the media capture device.

Example 32 includes the subject matter of Example 30 and wherein capturing data associated with the scene comprises capturing light, sound, vibration and movement data from the scene.

Example 33 includes the subject matter of Example 30 and wherein capturing data comprises a camera array having two or more lenses to capture the data.

Example 34 includes the subject matter of Example 33 and wherein a first of the two or more lenses to capture the scene data.

Example 35 includes the subject matter of Example 33 and wherein analyzing the scene data comprises analyzing the scene data to identify one or more objects in the scene.

Example 36 includes the subject matter of Example 33 and wherein analyzing the scene data comprises analyzing the scene data to recognize one or more faces in the scene.

Example 37 includes the subject matter of Example 34 and wherein analyzing the scene data comprises determining a source of sound input from a scene.

Example 38 includes the subject matter of Example 37 and wherein the source of sound input from the scene is determined based on sound data received from microphones and video analysis of mouth movement from data captured by the one or more lenses.

Example 39 includes the subject matter of Example 33 and wherein adjusting the media capture device comprises optimizing the two or more lenses to improve image capture.

Some embodiments pertain to Example 40 that includes an apparatus comprising means for detecting that a media capture device is prepared to capture media data of a scene, means for capturing data associated with the scene, means for analyzing the scene data to identify and classify behavior of one or more objects in the scene and means for adjusting the media capture device based on the scene data analysis to optimize the capture of the media data.

Example 41 includes the subject matter of Example 40 and further comprising means for capturing media data of the scene after adjusting the media capture device.

Example 42 includes the subject matter of Example 40 and wherein capturing data associated with the scene comprises means for capturing light, sound, vibration and movement data from the scene.

Example 43 includes the subject matter of Example 40 and wherein capturing data comprises a camera array having two or more lenses to capture the data.

Example 44 includes the subject matter of Example 43 and wherein a first of the two or more lenses to capture the scene data.

Example 45 includes the subject matter of Example 43 and wherein the means for analyzing the scene data comprises means for analyzing the scene data to identify one or more objects in the scene.

Example 46 includes the subject matter of Example 43 and wherein the means for analyzing the scene data comprises means for analyzing the scene data to recognize one or more faces in the scene.

Example 47 includes the subject matter of Example 44 and wherein the means for analyzing the scene data comprises means for determining a source of sound input from a scene.

Example 48 includes the subject matter of Example 47 and wherein the source of sound input from the scene is determined based on sound data received from microphones and video analysis of mouth movement from data captured by the one or more lenses.

Example 49 includes the subject matter of Example 43 and wherein the means for adjusting the media capture device comprises means for optimizing the two or more lenses to improve image capture.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

1. A computer-implemented method for performing pre-image analysis comprising:
detecting that a media capture device is prepared to capture media data of a scene;
capturing data associated with the scene;
analyzing the scene data to identify and classify behavior of one or more objects in the scene; and
adjusting the media capture device based on the scene data analysis to optimize the capture of the media data.

2. The method of claim 1 further comprising capturing media data of the scene after adjusting the media capture device.

3. The method of claim 1 wherein capturing data associated with the scene comprises capturing light, sound, vibration and movement data from the scene.

4. The method of claim 1 wherein capturing data comprises a camera array having two or more lenses to capture the data.

5. The method of claim 4 wherein a first of the two or more lenses to capture the scene data.

6. The method of claim 1 wherein analyzing the scene data comprises analyzing the scene data to identify one or more objects in the scene.

7. The method of claim 1 wherein analyzing the scene data comprises analyzing the scene data to recognize one or more faces in the scene.

8. The method of claim 5 wherein analyzing the scene data comprises determining a source of sound input from a scene.

9. The method of claim 8 wherein the source of sound input from the scene is determined based on sound data received from microphones and video analysis of mouth movement from data captured by the one or more lenses.

10. The method of claim 4 wherein adjusting the media capture device comprises optimizing the two or more lenses to improve image capture.

11. A media data management system comprising:
a media capture device to capture data associated with a scene prior to capturing media data for the scene; and
a middleware module to analyze the scene data to identify and classify behavior of one or more objects in the scene and adjust the media capture device based on the scene data analysis to optimize the capture of the media data.

12. The media data management system of claim 11 wherein the media capture device captures media data of the scene after the adjustment.

13. The media data management of claim 11 wherein the media capture device captures light, sound, vibration and movement data from the scene.

14. The media data management of claim 11 wherein the media capture device comprises a camera array having two or more lenses to capture the data.

15. The media data management of claim 14 wherein a first of the two or more lenses to capture the scene data.

16. The media data management of claim 15 wherein the middleware module comprises an object recognition module to identify one or more objects and in one or more faces in the scene.

17. The media data management of claim 16 wherein the media capture device comprises one or more microphones.

18. The media data management of claim 17 wherein the middleware module further comprises a sound source module to determine a source of sound input from the scene.

19. The media data management of claim 18 wherein the source of sound input from the scene is determined based on sound data received from microphones and video analysis of mouth movement from data captured by the one or more lenses.

20. The media data management of claim 14 wherein adjusting the media capture device comprises optimizing the two or more lenses to improve image capture.

21. A media capture device comprising:
media capture sensors to data capture associated with a scene prior to capturing media data for the scene; and
a middleware module to analyze the scene data to identify and classify behavior of one or more objects in the scene and adjust one or more of the media capture sensors based on the scene data analysis to optimize the capture of the media data.

22. The media capture device of claim 11 wherein the media capture sensors comprise:
a camera array having two or more lenses to capture the data; and
one or more microphones.

23. The media capture device of claim 15 wherein the middleware module comprises:
an object recognition module to identify one or more objects and in one or more faces in the scene; and
a sound source module to determine a source of sound input from the scene.

24. The media data management of claim 23 wherein the source of sound input from the scene is determined based on sound data received from microphones and video analysis of mouth movement from data captured by the one or more lenses.

25. A machine-readable medium comprising a plurality of instructions that in response to being executed on a computing device, causes the computing device to carry out operations comprising:
detecting that a media capture device is prepared to capture media data of a scene;
capturing data associated with the scene;
analyzing the scene data to identify and classify behavior of one or more objects in the scene; and
adjusting the media capture device based on the scene data analysis to optimize the capture of the media data.

26. The machine-readable medium of claim 25 comprising a plurality of instructions that in response to being executed on a computing device, causes the computing device to carry out further comprising capturing media data of the scene after adjusting the media capture device.

27. The machine-readable medium of claim 25 wherein capturing data associated with the scene comprises capturing light, sound, vibration and movement data from the scene.

28. The machine-readable medium of claim 25 wherein capturing data comprises a camera array having two or more lenses to capture the data.

29. The machine-readable medium of claim 28 wherein a first of the two or more lenses to capture the scene data.

30. The machine-readable medium of claim 25 wherein analyzing the scene data comprises analyzing the scene data to identify one or more objects in the scene.

31. The machine-readable medium of claim 25 wherein analyzing the scene data comprises analyzing the scene data to recognize one or more faces in the scene.

32. The machine-readable medium of claim 29 wherein analyzing the scene data comprises determining a source of sound input from a scene.

33. The machine-readable medium of claim 32 wherein the source of sound input from the scene is determined based on sound data received from microphones and video analysis of mouth movement from data captured by the one or more lenses.

34. The machine-readable medium of claim 28 wherein adjusting the media capture device comprises optimizing the two or more lenses to improve image capture.
